(19) United States
(12) Patent Application Publication
(10) Pub. No.: US 2021/0015697 A1
(43) Pub. Date: Jan. 21, 2021

(54) EYE-TRAINING APPARATUS AND METHODS FOR MODIFYING VISUAL INPUT TO THE BRAIN

(71) Applicants: CLIFFORD MOLLER, KATY, TX (US); WILLIAM BRILEY, SOMERVILLE, MA (US)

(72) Inventors: CLIFFORD MOLLER, KATY, TX (US); WILLIAM BRILEY, SOMERVILLE, MA (US)

(21) Appl. No.: 16/548,478

(22) Filed: Aug. 22, 2019

Related U.S. Application Data
(60) Provisional application No. 62/874,175, filed on Jul. 15, 2019.

(51) Int. Cl. A61H 5/00; G02F 1/17; G02F 1/163; G02F 1/133; G02F 1/1334

(52) U.S. Cl. CPC A61H 5/005; G02F 1/172; A61H 2201/1604; G02F 1/13306; G02F 1/1334; G02F 1/163

(57) ABSTRACT

An apparatus for modifying the visual input to the brain from a non-dominant eye is provided. The apparatus includes an electrically controllable optical window that is coupled with a controller. The controller is positioned to establish a voltage across the electrically controllable optical window, remove a voltage across the electrically controllable optical window, vary a voltage across the electrically controllable optical window, or combinations thereof. The optical transparency of the electrically controllable optical window is responsive to voltage across the electrically controllable optical window.

### CROSS-REFERENCE TO RELATED APPLICATIONS

This application claims the benefit of U.S. Provisional Patent Application No. 62/874,175 (pending), filed on Jul. 15, 2019, and entitled “EYE-TRAINING DEVICE FOR USE IN AIMING FIREARMS, AND METHODS OF MAKING AND USING THE SAME”, the entirety of which is incorporated herein by reference.

### FIELD

The present disclosure relates to apparatus and systems for causing the brain to at least temporarily prefer visual input from a non-dominant eye, as well as to methods of making and using the same.

### BACKGROUND

When shooting a gun, it is generally recommended that a shooter use his or her dominant eye (also referred to as the “shooters eye”) to aim with. The dominant eye is the eye that is stronger and more capable of maintaining focus, relative to the non-dominant eye. This is sometimes referred to as ocular dominance, eye preference, or eyedness. Also, when shooting a gun, it is generally recommended that a shooter use his or her dominant hand to pull the trigger with.

Some shooters exhibit “cross-dominance” (also referred to as “odd-eye dominance”), wherein the dominant hand is opposite the dominant eye. For example, a person that is left-handed with right-eye dominance exhibits cross-dominance, and a person that is right-handed with left-eye dominance exhibits cross-dominance. In shooting, cross-dominance can result in decreased accuracy and safety.

Attempts to address cross-dominance in shooting have included shooting with the dominant hand and non-dominant eye, while covering the dominant eye, such as with a patch or tape, in an attempt to “train” the non-dominant eye to have dominance. Such methods continuously block the view of the dominant eye during shooting. Many have found these methods to be unsuccessful and potentially dangerous.

Some children are born with amblyopia, known as a “lazy eye.” This disorder is currently treated by making the child wear an eyepatch over the child's healthy eye; thereby, forcing the child to use the “lazy” eye for vision. Thus, in addition to being forced to wear an eye patch in public, the child undergoing such treatment is limited to monocular vision, as binocular vision is prevented.

### BRIEF SUMMARY

Some embodiments of the present disclosure include an apparatus for modifying visual input to the brain. The apparatus includes an electrically controllable optical window. A controller is electrically coupled with the electrically controllable optical window. The controller is positioned to establish a voltage across the electrically controllable optical window, remove a voltage across the electrically controllable optical window, vary a voltage across the electrically controllable optical window, or combinations thereof. Optical transparency of the electrically controllable optical window is responsive to voltage across the electrically controllable optical window.

Another embodiment of the present disclosure includes a method for modifying visual input to the brain. The method incudes positioning an electrically controllable optical window within the field of vision of a dominant eye. The method includes establishing a voltage across the electrically controllable optical window, removing a voltage across the electrically controllable optical window, varying a voltage across the electrically controllable optical window, or combinations thereof. Optical transparency of the electrically controllable optical window is responsive to voltage across the electrically controllable optical window.

Another embodiment of the present disclosure includes a pair of glasses for modifying visual input to the brain. The pair of glasses include a frame and two optical windows coupled with the frame. At least one of the optical windows is an electrically controllable optical window. A controller is electrically coupled with the electrically controllable optical window. The controller is positioned to establish a voltage across the electrically controllable optical window, remove a voltage across the electrically controllable optical window, vary a voltage across the electrically controllable optical window, or combinations thereof. Optical transparency of the electrically controllable optical window is responsive to voltage across the electrically controllable optical window.

### BRIEF DESCRIPTION OF THE DRAWINGS

So that the manner in which the features and advantages of the system, apparatus, and method may be understood in more detail, a more particular description may be had by reference to the embodiments which are illustrated in the appended drawings that form a part of this specification. It is to be noted, however, that the drawings illustrate only various exemplary embodiments and are therefore not to be considered limiting of the disclosed concepts as it may include other effective embodiments as well.

FIGS. 1A and 1B are simplified schematics showing the effects of cross-dominance without and with use of the apparatus, respectively.

FIG. 2 is a simplified schematic of an apparatus for training a non-dominant eye to at least temporarily be a dominant eye.

FIG. 3A depicts a pair of eye glass that include the apparatus of FIG. 2 attached thereto.

FIG. 3B depicts a pair of eye glass with an embodiment of the apparatus integrated therewith.

FIG. 3C depicts a pair of eye glass that include the apparatus of FIG. 2 attached thereto.

FIG. 3D depicts a pair of eye glass with a single window or lens and having the apparatus coupled therewith.

FIG. 3E depicts another pair of eye glass with a single window or lens and having the apparatus coupled therewith.

FIG. 3F depicts a pair of eye glass with a single window or lens and having the apparatus integrated therewith.

FIG. 3G depicts another pair of eye glass with a single window or lens and having the apparatus integrated therewith.

FIG. 4 is a schematic of the apparatus disclosed herein.

FIGS. 5A-5C depict an electrically controllable optical window in three different states of optical transparency.

FIGS. 6A and 6B show light transmission through optical windows of different opacities.

Apparatus, systems, products, and methods according to present disclosure will now be described more fully with reference to the accompanying drawings, which illustrate various exemplary embodiments. Concepts according to the present disclosure may, however, be embodied in many different forms and should not be construed as being limited by the illustrated embodiments set forth herein. Rather, these embodiments are provided so that this disclosure will be thorough as well as complete and will fully convey the scope of the various concepts to those skilled in the art and the best and preferred modes of practice.

### DETAILED DESCRIPTION

Certain embodiments of the present disclosure include apparatus and systems for at least temporarily training the sight on a non-dominant eye and/or for training a non-dominant eye to, at least temporarily, function as a dominant eye. As used herein a “dominant eye” is a person's eye that is stronger and more capable of attaining and maintaining optical focus on a point of interest (e.g., a shooting target) than the person's other eye (i.e., the non-dominant eye). In some embodiments, the dominant eye of a person is determined by subjective alignment of two objects at a stereo-disparity past Panum's area. The dominant eye may be determined in accordance with the Miles test, the Porta test, the Dolman method, the convergence near-point test, stereograms, the pinhole test, the ring test, the lens fogging technique, or a dichoptic motion coherence threshold test. As used herein, the “non-dominant eye” is the eye of a person that is not the dominant eye. As would be understood by those skilled in the art, certain people may not have a dominant and non-dominant eye. The dominance or non-dominance of an eye may be determined by the brain's preference for use of visual input of one eye relative to the brain's preference for use of visual input of the other eye. Some embodiments disclosed herein include apparatus and methods for modifying visual input to the brain, such that the visual input to the brain from a dominant eye is disrupted or impaired and the visual input to the brain from a non-dominant eye is not disrupted or impaired (or is less disrupted or impaired than the dominant eye). Without being bound by theory, it is believed that, with the visual input of the dominant eye disrupted or impaired and the visual input of the non-dominate eye not disrupted or impaired (or less disrupted or impaired), the brain will at least temporarily favor the visual input to the brain from the non-dominant eye. As used herein with respect to “visual input”, “disrupted” and “impaired” refer to an elimination of or a reduction of visual input from an eye to the brain. For example, in some embodiments an opaque optical window disrupts or impairs transmission of light to the dominant eye such that visual input from the dominate eye to the brain is, in-turn, disrupted or impaired.

### Cross-Dominance

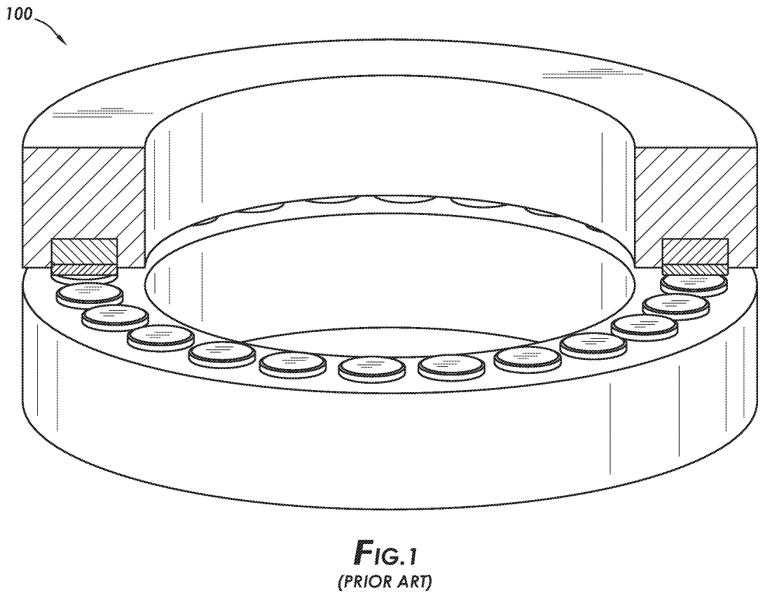

With reference to FIG. 1A, a simplified schematic that is representative of a user shooting at a target is shown. User 100 in FIG. 1A is a left-handed user. Thus, the typical recommendation for such a left-handed user 100 would be to shoot with the left hand pulling the trigger, requiring the left-eye 102 to be the eye that predominantly bears the burden of focusing on target 106. However, in this example, user 100 is right-eye 104 dominant, such that the user exhibits cross-dominance. As shown in FIG. 1A, shooting when cross-dominant can result in the bullet following an off-target trajectory 110 rather than an on-target trajectory 112; thereby, missing the target 106 and instead hitting a location 108 that is off-target. This can result in a reduction in shooting accuracy, and can also be dangerous, as the bullets are moving along unexpected and undesired trajectories. With reference to FIG. 1B, user 100 is now wearing apparatus 1000, such that an electrically controllable (e.g., switchable) optical window (e.g. glass or plastic) of apparatus is positioned in front of the user's typically dominant right-eye 104. In some embodiments, the optical windows disclosed herein are refractive (e.g., refractive lenses). In other embodiments, the optical windows disclosed herein are non-refractive (e.g., non-refractive lenses).

As described in more detail below, apparatus 1000 includes an electrically controllable optical window that is positioned over the dominant eye of the user. As used herein, an “electrically controllable optical window” refers to an optical window that has a variable optical state of opacity that is varies in response to the application of voltage across the optical window. The electrically controllable optical window alternates (e.g., cycles) between optical states, including a relatively opaque or shaded state and a relatively transparent or non-shaded state. Without being bound by theory, it is believed that such alternating or cycling disrupts or impairs the normally dominant focus of the normally dominant eye, causing the brain to cease favoring visual input from the normally dominant eye and to instead favor visual input from the normally non-dominant eye. As such, the normally non-dominant eye is capable of more accurate and sustained focus in comparison to when apparatus 1000 is not worn in front of the normally dominant eye. In some embodiments, the improvement of the focus of the normally non-dominant eye is temporally limited to only when apparatus 1000 is worn in front of the normally dominant eye and is alternating between a relatively opaque or shaded state and a relatively transparent or non-shaded state. In other embodiments, the improvement of the focus of the normally non-dominant eye is not temporally limited to only when apparatus 1000 is worn in front of the normally dominant eye and is alternating between a relatively opaque or shaded state and a relatively transparent or non-shaded state. With further reference to FIG. 1B, with user 100 wearing apparatus 1000, the focus of user's 100 left-eye 102 is at least temporarily improved such that user 100 is capable of shooting the bullet along on-target trajectory 112 rather than off-target trajectory 110; thereby, increasing the chance of the user hitting target 106 instead of hitting a location 108 that is off-target. Thus, use of apparatus 1000 can result in an increase in shooting accuracy, and can also increase the safety of shooting activities, as the bullets are moving along expected and desired trajectories.

When apparatus 1000 is worn by a user, the user's binocular vision is maintained. That is, while apparatus 1000 is positioned in front of the user's dominant eye and is operating in altering states of opacity, the user is still capable of seeing with both eyes.

In some embodiments, the optical state of the optically controllable windows disclosed herein is cyclical, such that the optically controllable windows cycle through at least two different optical states in a regular cycle. In some embodiments, the optical state of the optically controllable windows disclosed herein is not regular, but is random or varies, such that the optically controllable windows alternate through multiple different optical states in an irregular pattern or at random.

In some embodiments, the optical state of the optically controllable window is only variable between two optical states, such as a first state when a voltage is applied and a second state when no voltage is applied or when a different voltage is applied. In other embodiments, the optical state of the optically controllable window is variable between more than two optical states, such as a first state when a first voltage is applied, a second state when no voltage is applied or a second voltage is applied that is different than the first, and one or more additional states when additional voltages are applied that are different than the first and optional second voltage. That is, in some embodiments the optical state of the optically controllable window is gradient in response to gradient voltages applied there-across.

### Schematic of Apparatus

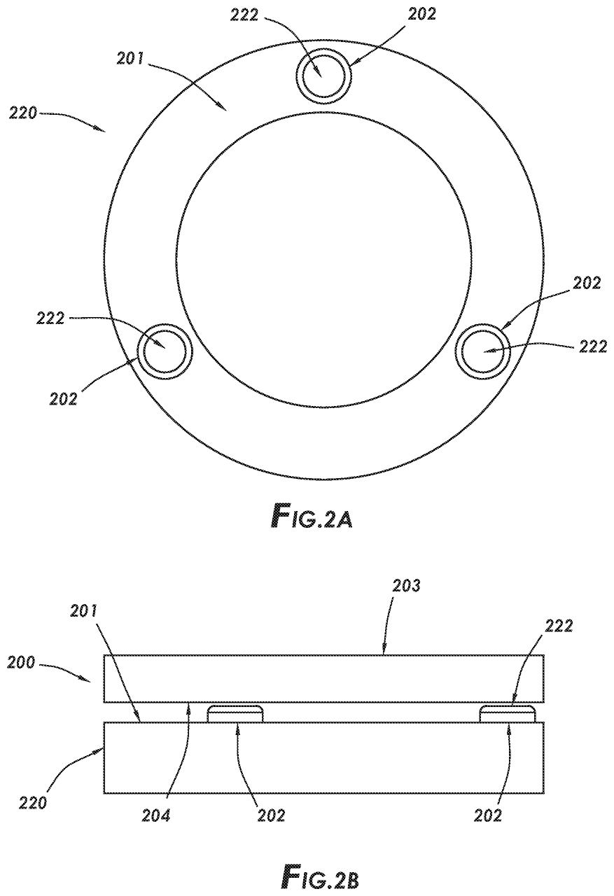

With reference to FIG. 2, apparatus 1000 is depicted. Apparatus 1000 includes electrically controllable optical window 1002. One skilled in the art would understand that the material that may be used as the electrically controllable optical window may be glass or polymer or other material. Electrically controllable optical window may be or include a material that has optical properties responsive to voltage, such that electrically controllable optical window is controllable between at least two different optical states of opacity and/or transparency. In use, electrically controllable optical window 1002 is positioned in front of a user's normally dominant eye to at least partially obstruct the view of the normally dominant eye.

In some embodiments, electrically controllable optical window 1002 is or includes a smart glass or controllable glass, which may be a glass or glazing on a glass having light transmission properties that are alterable when voltage is applied thereto, such that electrically controllable optical window 10002 may be cycled between a state of opaque translucence and clear transparency. For example, when voltage is applied to electrically controllable optical window 1002, at least some wavelengths of light may be prevented from passing therethrough, and when voltage is not applied to electrically controllable optical window 1002, such wavelengths are not prevented from passing therethrough. In some embodiments, the opposite is the case, where when voltage is not applied to electrically controllable optical window 1002, at least some wavelengths of light may be prevented from passing therethrough, and when voltage is applied to electrically controllable optical window 1002, such wavelengths are not prevented from passing therethrough.

In some embodiments, electrically controllable optical window 1002 is or includes a suspended-particle device (SPD), including a thin film laminate. The laminate includes two layers of glass or plastic having particles positioned therebetween. The particles may be rod-like nano-scale particles that are suspended in a liquid. In some embodiments, the particles are attached to at least one of the layers. In such embodiments, the particles are exhibit a random orientation without voltage, and an align orientation with voltage applied thereto. As such, wavelengths of light are blocked when voltage is not applied and are not blocked when voltage is applied. In some such embodiments, electrically controllable optical window 1002 is electrochromic, electrically controllable smart glass. In such embodiments, voltage applied to electrically controllable optical window 1002 modifies the opacity of electrically controllable optical window 1002. Electricity may be applied to modify the opacity, but, in some embodiments, is not required to be continually applied to maintain electrically controllable optical window 1002 in the modified state. In some embodiments, electrically controllable optical window 1002 is or includes a polymer-dispersed liquid-crystal device (PDLC) that varies in light transmittance with voltage applied.

Apparatus 1000 includes controller 1004. Controller 1004 may be an electronic switch, circuit board, printed circuit board (PCB), computer processor (e.g., semiconductor chip) or other device capable of generating a voltage across electrically controllable optical window 1002, controlling the generation of a voltage across electrically controllable optical window 1002, transmitting a voltage across electrically controllable optical window 1002, controlling the transmission of a voltage across electrically controllable optical window 1002, or combinations thereof. In some embodiments, controller 1004 is a computer or a portion of a computer. For example, apparatus 1000 may include power source 1006, such as a battery, which may be electronically coupled with controller 1004 via electronic coupling 1008 (e.g., a wire). Controller 1004 may be or include a switch capable of opening and closing to establish and remove a voltage across electrically controllable optical window 1002 via electronic coupling with power source 1006 and optical window 1002 via electronic couplings 1008 and 1010 (e.g., wires). In some embodiments, apparatus 1000 includes one or more switches, buttons, or knobs 1012 for controlling one or more parameters of apparatus, such as the voltage, and the rate of cycling between voltage being applied and not being applied across electrically controllable optical window 1002.

In some embodiments, the voltage is applied across electrically controllable optical window 1002 in a pattern. The pattern may be a pattern of voltages in series, such as a first voltage, followed by a second voltage, followed by no voltage, followed by the first voltage, and so forth in the same pattern. Parameters of the voltage pattern may include, but are not limited to: how long each voltage is maintained across the electrically controllable optical window, the absolute value of each voltage, the differential between the various voltages, the frequency of switching from one voltage to another, the total duration, in time, of the voltage pattern, and the number of different voltages in the voltage pattern. In some embodiments, the voltage randomly alternates.

### Glasses

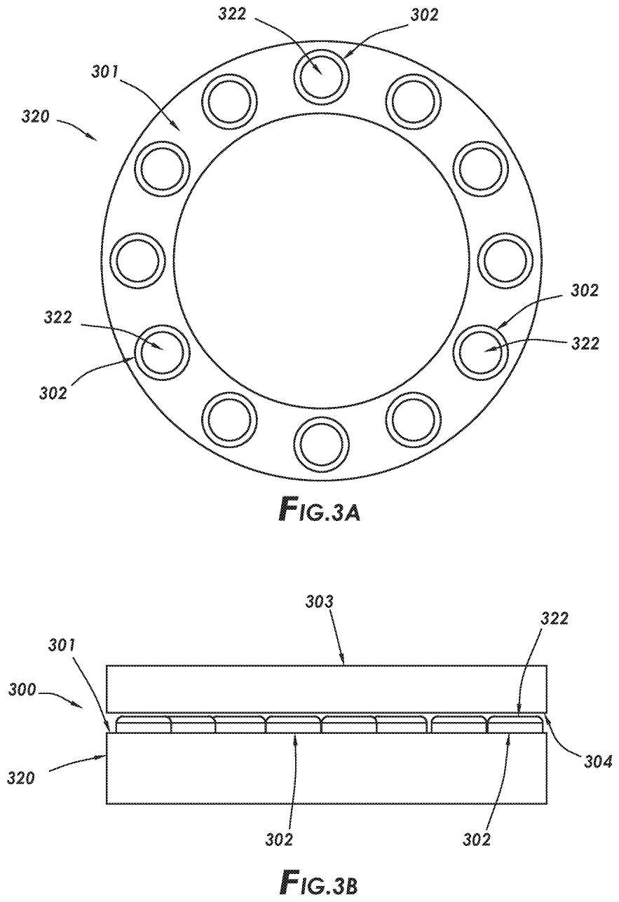

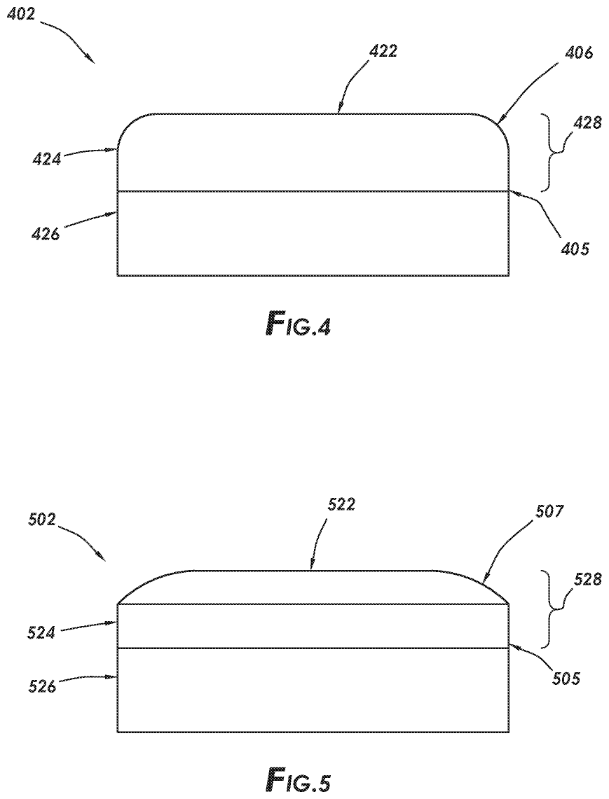

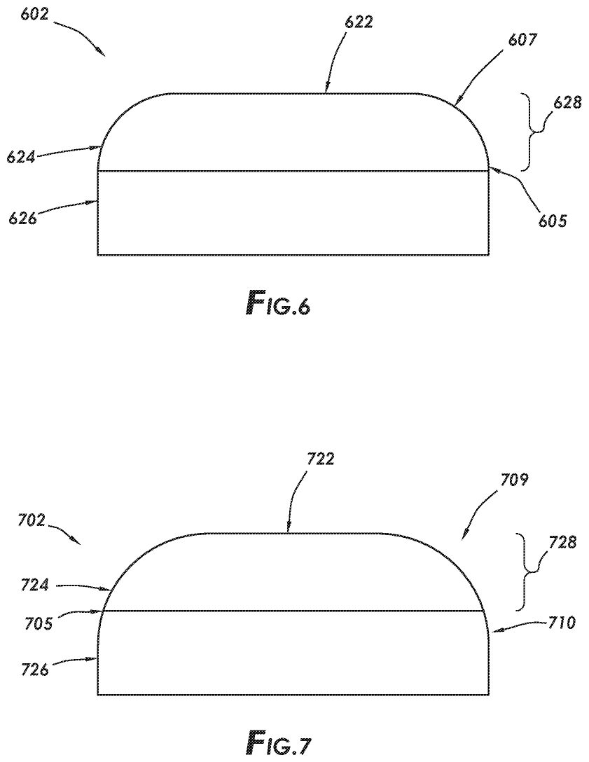

In some embodiments, the apparatus and systems are or include a pair of eye glasses, or an accessory that is attachable to and usable with a pair of eye glasses. With reference to FIG. 3A, one exemplary pair of glasses 200a is shown. Glasses 200a include frame 202a and optical windows 204a and 204b. As shown, optical window 204a is free of apparatus 1000a, and optical window 204b includes apparatus 1000a coupled therewith. In some embodiments, apparatus 1000a is a separate, discrete element that is coupled with glasses 200a. Apparatus 1000a may be clipped, adhered, strapped, snapped, press fit, or otherwise coupled with frame 202a, optical window 204a, optical window 204b, or another portion of glasses 200a. In other embodiments, the apparatus is integral with glasses (as shown in FIG. 3B), such that the apparatus and glasses are portions a unitary structure. Glasses 200a include controller 1004a. Controller 1004a is coupled with electrically controllable optical window 1002a via wire 1010a for controlling the voltage there-across.

With reference to FIG. 3B, one exemplary pair of glasses 200b is shown. Glasses 200b include frame 202b and apparatus 1000b, including optical windows 1002b and 1002c. Optical windows 1002b and 1002c are electrically controllable optical windows in accordance with the present disclosure. Controllers 1004b and 1004c are coupled with optical windows 1002b and 1002c for selectively switching (or otherwise controlling) optical windows 1002b and 1002c between different states of opacity and transparency by applying voltage there-across. While shown as including two controllers 1004a and 1004b, one for each optical window 1002b and 1002c, such a pair of glasses 200b may include a single controller that is capable of selectively controlling either of optical windows 1002b and 1002c. Also, while shown as including two optical windows 1002b and 1002c that are electrically controllable, glasses 200b may include only one electrically controllable optical window. Controllers 1004b and 1004c are coupled with optical windows 1002b and 1002c, respectively, via wires 1010b and 1010c, respectively.

While shown and described herein as coupled with or integral with glasses, the apparatus disclosed herein is not limited to being used with glasses, and may be used alone or coupled with another article, or used in any manner such that electrically controllable optical window 1002 is positioned in front of one of the user's eye. For example, apparatus 1000 may be coupled with a strap that may be worn about a user's head such that electrically controllable optical window 1002 is positioned in front of one of the user's eye.

While shown as including two optical windows, in some embodiments the glasses disclosed herein only include one optical window. For example, FIGS. 3C-3G depict additional embodiments of apparatus 1000, with varying arrangements optical windows and electrically controllable optical windows, with like reference numerals indicating like elements with respect to FIGS. 3A and 3B.

### Schematic of System Components

In some embodiments the apparatus disclosed herein includes memory, computer logic, sensors, data communication capabilities, or combinations thereof. With reference to FIG. 4, a schematic of apparatus 1000 is depicted.

Apparatus 1000 includes electrically controllable optical window 1002 coupled with controller 1004, which is coupled with power source 1006.

Apparatus 1000 includes memory, data storage 1003, such as a computer readable medium. Data storage 1003 may be in communication with controller 1004, or may be integral therewith. Data storage 1003 may store various data, including user settings 1017 and usage history 1019 of apparatus 1000. User settings 1017 may be or include user name, user preferred voltage pattern, user target hits and misses, and other user data. Usage history 1019 may be or include data regarding past use of the device, such as the number of times the device has been used.

Apparatus 1000 includes one or more sensors 1007 in communication with data storage 1003, controller 1004, or combinations thereof. Some exemplary sensors that apparatus 1000 may include are optical sensors and motion sensors. Sensors 1007 may collect sensor data 1015, and transmit the sensor data 1015 to data storage 1003 for storage therein. In some embodiments, controller 1004 may control the operation of electrically controllable optical window 1002 in response to sensor data 1015 from sensors 1007. For example, apparatus 1000 includes computer logic, which may be in the form of computer instructions 1005 stored in data storage 1003. Computer instructions 1005 may be or include computer instructions to instruct controller 1004 to control the voltage across electrically controllable optical window 1002 in response to sensor data 1015. In one example, sensors 1007 include an optical sensor for sensing ambient light, and controller 1004 may operate, in response to sensor data 1015 and computer instructions 1005, to adjust the voltages applied across electrically controllable optical window 1002 in response to the ambient light detected. For example, a clear sunny day may require a different voltage than a cloudy day for attaining the desired degree of opacity or transparency. In another example, sensors 1007 include a motion detector for sensing motion, and controller 1004 may operate, in response to sensor data 1015 and computer instructions 1005, to turn on or off in response to detected motion or lack thereof. For example, after 10 minutes of detected inactivity or motion, apparatus 1000 may shut off. In some embodiments, sensors 1007 are coupled with glasses.

Apparatus 1000 includes communication hardware 1009. Communication hardware 1009 may be coupled with data storage 1003, controller 1004, or combinations thereof. Communication hardware 1009 may be or include hardware for receipt of and transmission of data and other communications, such as antennas, transceivers, or other equipment. Communication hardware 1009 may be or include an RF antenna for communication, via Bluetooth, WI-FI, NFC, or other communication protocols, with external device 1111. For example, external device 1111 may be a cellular phone, computer, tablet computer, or other such device. In some embodiments, a software application (App) on external device 1111 may allow for remote control of apparatus 1000 via commination with communication hardware 1009. For example, externa device 1111 may be used to turn apparatus on and off, to turn the voltage across electrically controllable optical window 1002 on and off, to adjust the voltage of across electrically controllable optical window 1002, or adjust or control other parameters of apparatus 1000. For example, if apparatus 1000 is capable of communication via NFC, a user may tap apparatus 1000 with an NFC-enabled smartphone to transfers recorded data from data storage 1003 to the user's phone.

Power source 1006 of apparatus 1000 may be or include replaceable batteries. In some embodiments, power source 1006 is re-chargeable, such as via wired (e.g., USB) connection with an external power supply through a charging port, wireless induction, or solar charging.

Apparatus 1000 includes one or more controls 1012a-1012d (e.g., switches, buttons, or knobs) for controlling one or more parameters of apparatus 1000, such as the voltage, and the rate of alternating between voltage being applied and not being applied across electrically controllable optical window 1002. Such parameters may be adjusted based upon the environmental conditions, for example. In some embodiments, controls 1012a-1012d include controls for selecting a user. For example, apparatus 1000 may be configured from more than one user to operate. In such embodiments, apparatus 1000 may be designed such that apparatus 1000 may operate in multiple different user settings. For example, a first user may push the “user 1” button, button 1012a, to initiate the user settings associated with the first user, and a second user may push the “user 2” button, button 1012b, to initiate the user settings associated with the second user. Each user setting may vary from other user settings by the voltage, opacity, transparency, frequency of alternating the voltage, or other settings. Users may push button 1012c to indicate whether or not the target was hit by the user after firing a shot. User data 1021 may be stored in data storage 1003. The ability to track whether or not the target was hit allows users to track their performance. In addition to target hit accuracy, user data 1021 may include voltage, opacity, transparency, and frequency alternating the voltage, allowing users to identify apparatus settings that are associated with greater target hitting accuracy. In operation, the electrically controllable optical window 1002 is, in some embodiments, responsive to multiple inputs, including sensor data 1015 as well as user controls 1012a-1012d.

Some operational variables that each user may vary via controls include, but are not limited to: voltage, frequency of voltage changes, gradience of voltage changes, the length of time that the optical window remains opaque, the length of time that the optical window remains transparent, and the regularity or randomness of the alternations from opaque to transparent. Also, users may vary the length of time that the apparatus is worn by the user. For example, the apparatus could provide a visible or audible signal, via signaling device 1023, when a certain amount of time has passed so that the user is altered to take the device off or to put the device on.

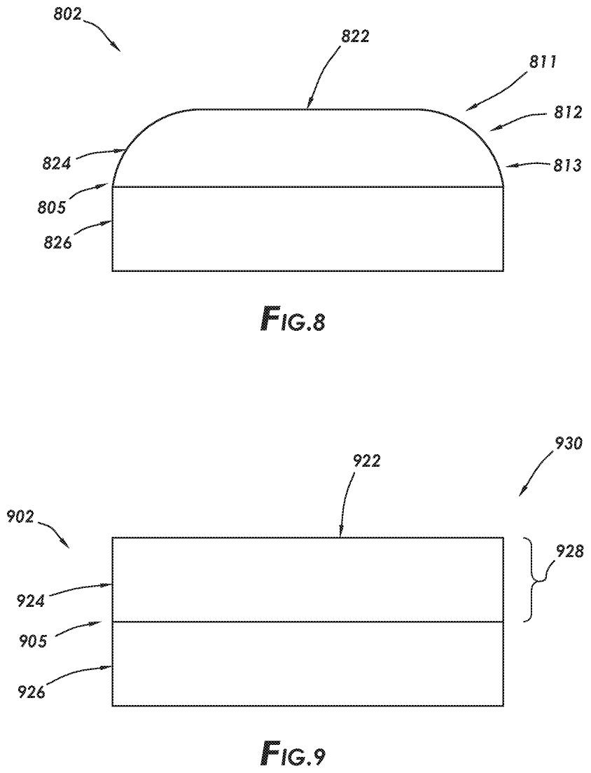

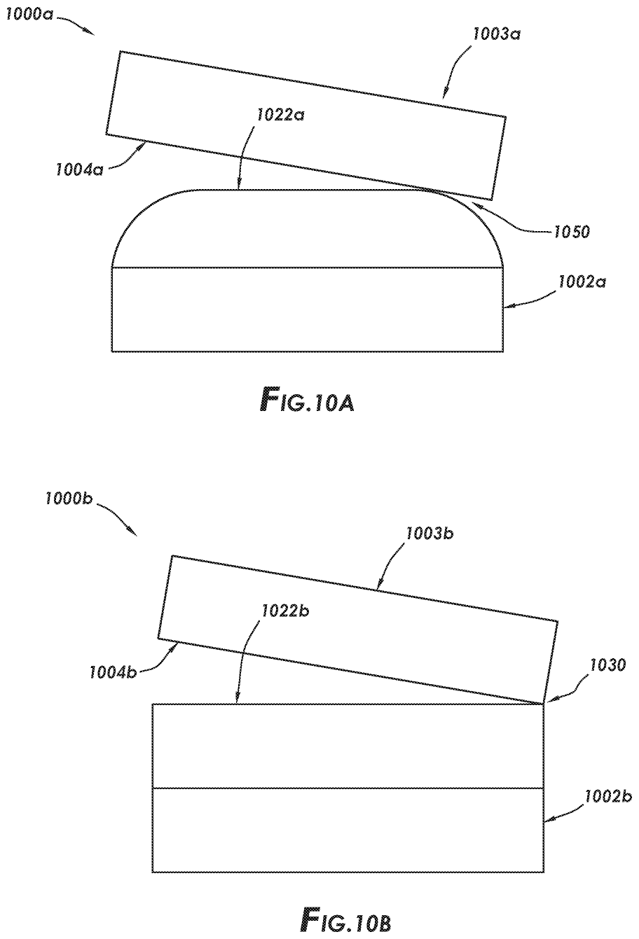

FIGS. 5A-5C depict electrically controllable optical windows in three different states of optical transparency. In FIG. 5A, electrically controllable optical window 1002a is relatively opaque, in comparison to electrically controllable optical windows 1002b and 1002c, shown in FIGS. 5B and 5C, respectively. In FIG. 5C, electrically controllable optical window 1002c is relatively transparent, in comparison to electrically controllable optical windows 1002a and 1002b, shown in FIGS. 5A and 5B, respectively. In FIG. 5B, electrically controllable optical window 1002b has an opacity/transparency that is intermediate of electrically controllable optical windows 1002a and 1002c, shown in FIGS. 5A and 5C, respectively.

FIGS. 6A and 6B show light transmission through optical windows of different opacities. In FIG. 6A, optical window 1002 is in a relatively transparent optical state, with light 6000 passing through optical window 1002. While all light 6000 is shown passing from the left side of optical window 1002, through optical window 1002, and to the right side of optical window 1002, the optical windows disclosed herein, when in the relatively transparent state, may allow less than all of the light to pass there-through. In FIG. 6B, optical window 1002 is in a relatively opaque optical state, with no light 6000 passing through optical window 1002. While all light 6000 is shown as not passing from the left side of optical window 1002, through optical window 1002, and to the right side of optical window 1002, the optical windows disclosed herein, when in the relatively opaque state, may allow some of the light to pass there-through. Light 6000 that does not pass through optical window 1002 may be absorbed or reflected, for example.

### Methods of Use

Some embodiments of the present disclosure include methods of shooting while using a normally non-dominant eye to focus and aim. In some embodiments, the method includes training or facilitating a non-dominant eye to be, at least temporarily, a dominant eye. The method includes: (1) positioning an electrically controllable optical window (e.g., electrically controllable optical window 1002) in accordance with the present disclosure within the field of vision of a dominant eye; (2) cycling the electrically controllable optical window between a state of relative opacity and a state of relative transparency such that a non-dominant eye is at least temporarily functioning as a dominant eye; and (3) aiming and shooting a gun while focusing with the non-dominant eye. In some embodiments, the non-dominant eye is at least temporarily functioning as the dominant eye while aiming and shooting. That is, the visual input from the non-dominant eye is favored by the brain relative to the visual input from the dominant eye as a result of the alternating of the electrically controllable optical window, positioned in front of the dominant eye, between states of relative opacity and states of relative transparency.

In some embodiments, the electrically controllable optical window continuously cycles or alternates between opaque and transparent states at a rate of 10 times per second. In other embodiments, the electrically controllable optical window continuously cycles or alternates between opaque and transparent states at a rate of less than or greater than 10 times per second.

While described herein as used in conjunction with the shooting of a gun, the apparatus disclosed herein may be used in conjunction with other activities that require or benefit from visual focus and/or hand-eye coordination, such as archery and darts.

Without being bound by theory, it is believed that in some applications the apparatus disclosed herein may be used in methods of therapeutic treatment of an eye or eyes. For example, the apparatus may be used to train or treat a “lazy eye” (amblyopia), such that the user's brain ceases to ignore input from the user's “lazy eye” or at least ignores input from the user's “lazy eye” to a lesser degree than prior to use of the apparatus. In some embodiments, short-term usage of the apparatus may at least temporarily shift eye dominance in users that suffer from “lazy eye”. In some embodiments, long-term usage of the apparatus may train or strengthen a lazy eye. Usage of the apparatus disclosed herein to treat lazy eye provides for binocular vision during treatment, and does not require an eye patch to be worn. In some such embodiments, the glasses disclosed herein, used for treatment of “lazy eye” aesthetically appear to be typical sunglasses to those not wearing the glasses, while providing treatment to the wearer of the glasses. While the apparatus disclosed herein is described as being used to help improve aim and focus, and to provide for therapeutic treatment of amblyopia, the apparatus is not limited to such uses, and may be used to provide therapeutic treatment for other ailments or conditions of the eye, or for other non-therapeutic uses.

### EMBODIMENTS

Certain embodiments will now be set forth.

Embodiment 1. An apparatus comprising: an electrically controllable optical window; and a controller electrically coupled with the electrically controllable optical window; and wherein the controller is positioned to establish a voltage across the electrically controllable optical window, remove a voltage across the electrically controllable optical window, vary a voltage across the electrically controllable optical window, or combinations thereof; and wherein optical transparency of the electrically controllable optical window is responsive to voltage across the electrically controllable optical window.

Embodiment 2. The apparatus of embodiment 1, wherein the controller is positioned to establish at least two different voltage states across the electrically controllable optical window, wherein in a first voltage state the electrically controllable optical window is in a first state of optical transparency, wherein in a second voltage state the electrically controllable optical window is in a second state of optical transparency, and wherein the first and second states of optical transparency are different.

Embodiment 3. The apparatus of embodiment 2, wherein the first state of optical transparency is opaquer than the second state of optical transparency.

Embodiment 4. The apparatus of embodiment 2, wherein the second state of optical transparency is opaquer than the first state of optical transparency.

Embodiment 5. The apparatus of any of embodiments 1 to 4, wherein the controller comprises an electronic switch, a circuit board, or a computer processor.

Embodiment 6. The apparatus of any of embodiments 1 5, further comprising a source of electricity coupled with the controller.

Embodiment 7. The apparatus of any of embodiments 1 to 6, wherein the electrically controllable optical window comprises a smart glass.

Embodiment 8. The apparatus of embodiment 7, wherein the smart glass comprises a suspended-particle device (SPD), an electrochromic glass, or a polymer-dispersed liquid-crystal device (PDLC).

Embodiment 9. The apparatus of any of embodiments 1 to 8, wherein the apparatus is coupled with or integral with a pair of glasses, such that the electrically controllable optical window is positionable to at least partially obstruct a view of a user's normally dominant eye when the glasses are worn by the user.

Embodiment 10. The apparatus of embodiment 9, wherein the electrically controllable optical window is selectively attachable and detachable to the glasses to at least partially obstruct a view of either of a user's eyes when the glasses are worn by the user.

Embodiment 11. The apparatus of any of embodiments 1 to 10, further comprising: a data storage in communication with or integral with the controller; and one or more sensors in communication with the data storage, the controller, or combinations thereof; wherein voltage applied across the electrically controllable optical window by the controller is responsive to sensor data from the one or more sensors.

Embodiment 12. The apparatus of embodiment 11, wherein voltage applied across the electrically controllable optical window by the controller is responsive to ambient light detected by the one or more sensors.

Embodiment 13. The apparatus of embodiment 11 or 12, further comprising communication hardware in communication with the with the data storage, the controller, or combinations thereof, wherein the controller is remotely controllable by external devices via communication with the external devices through the communication hardware.

Embodiment 14. The apparatus of any of embodiments 1 to 13, further comprising one or more controls coupled with the controller for varying voltage, frequency of alternating voltage, length of time that each voltage is applied, or combinations thereof.

Embodiment 15. A method comprising: positioning an electrically controllable optical window within the field of vision of a dominant eye; and establishing a voltage across the electrically controllable optical window, removing a voltage across the electrically controllable optical window, varying a voltage across the electrically controllable optical window, or combinations thereof; wherein optical transparency of the electrically controllable optical window is responsive to voltage across the electrically controllable optical window.

Embodiment 16. The method of embodiment 15, further comprising aiming and shooting a gun while focusing with the non-dominant eye that is at least temporarily functioning as the dominant eye, aiming and shooting an arrow while focusing with the non-dominant eye that is at least temporarily functioning as the dominant eye, or aiming and throwing a dart while focusing with the non-dominant eye that is at least temporarily functioning as the dominant eye.

Embodiment 17. The method of embodiment 16, wherein the gun, arrow, or dart is aimed at a target, the method further comprising tracking whether the target is hit by shot from the gun, by the arrow, or by the dart, and determining a voltage or pattern of voltages across the electrically controllable optical window that is associated with a higher accuracy of hitting the target.

Embodiment 18. The method of any of embodiments 15 to 17, wherein the user has amblyopia.

Embodiment 19. A pair of glasses, the pair of glasses comprising: a frame; two optical windows coupled with the frame, wherein at least one of the optical windows is an electrically controllable optical window; and controller electrically coupled with the electrically controllable optical window; wherein the controller is positioned to establish a voltage across the electrically controllable optical window, remove a voltage across the electrically controllable optical window, vary a voltage across the electrically controllable optical window, or combinations thereof; and wherein optical transparency of the electrically controllable optical window is responsive to voltage across the electrically controllable optical window.

Embodiment 20. The apparatus of embodiment 19, wherein the controller is positioned to establish at least two different voltage states across the electrically controllable optical window, wherein in a first voltage state the electrically controllable optical window is in a first state of optical transparency, wherein in a second voltage state the electrically controllable optical window is in a second state of optical transparency, and wherein the first and second states of optical transparency are different.

Although the present embodiments and advantages have been described in detail, it should be understood that various changes, substitutions and alterations can be made herein without departing from the spirit and scope of the disclosure. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An apparatus for modifying visual input to the brain, the apparatus comprising:
an electrically controllable optical window; and
a controller electrically coupled with the electrically controllable optical window; and
wherein the controller is positioned to establish a voltage across the electrically controllable optical window, remove a voltage across the electrically controllable optical window, vary a voltage across the electrically controllable optical window, or combinations thereof; and
wherein optical transparency of the electrically controllable optical window is responsive to voltage across the electrically controllable optical window.

2. The apparatus of claim 1, wherein the controller is positioned to establish at least two different voltage states across the electrically controllable optical window, wherein in a first voltage state the electrically controllable optical window is in a first state of optical transparency, wherein in a second voltage state the electrically controllable optical window is in a second state of optical transparency, and wherein the first and second states of optical transparency are different.

3. The apparatus of claim 2, wherein the first state of optical transparency is opaquer than the second state of optical transparency.

4. The apparatus of claim 2, wherein the second state of optical transparency is opaquer than the first state of optical transparency.

5. The apparatus of claim 1, wherein the controller comprises an electronic switch, a circuit board, or a computer processor.

6. The apparatus of claim 1, further comprising a source of electricity coupled with the controller.

7. The apparatus of claim 1, wherein the electrically controllable optical window comprises a smart glass.

8. The apparatus of claim 7, wherein the smart glass comprises a suspended-particle device (SPD), an electrochromic glass, or a polymer-dispersed liquid-crystal device (PDLC).

9. The apparatus of claim 1, wherein the apparatus is coupled with or integral with a pair of glasses, such that the electrically controllable optical window is positionable to at least partially obstruct a view of a user's normally dominant eye when the glasses are worn by the user.

10. The apparatus of claim 9, wherein the electrically controllable optical window is selectively attachable and detachable to the glasses to at least partially obstruct a view of either of a user's eyes when the glasses are worn by the user.

11. The apparatus of claim 1, further comprising:
a data storage in communication with or integral with the controller; and
one or more sensors in communication with the data storage, the controller, or combinations thereof;
wherein voltage applied across the electrically controllable optical window by the controller is responsive to sensor data from the one or more sensors.

12. The apparatus of claim 11, wherein voltage applied across the electrically controllable optical window by the controller is responsive to ambient light detected by the one or more sensors.

13. The apparatus of claim 11, further comprising communication hardware in communication with the with the data storage, the controller, or combinations thereof, wherein the controller is remotely controllable by external devices via communication with the external devices through the communication hardware.

14. The apparatus of claim 1, further comprising one or more controls coupled with the controller for varying voltage, frequency of alternating voltage, length of time that each voltage is applied, or combinations thereof.

15. A method of modifying visual input to a user's brain, the method comprising:
positioning an electrically controllable optical window within the field of vision of a dominant eye; and
establishing a voltage across the electrically controllable optical window, removing a voltage across the electrically controllable optical window, varying a voltage across the electrically controllable optical window, or combinations thereof;
wherein optical transparency of the electrically controllable optical window is responsive to voltage across the electrically controllable optical window.

16. The method of claim 15, further comprising aiming and shooting a gun while focusing with the non-dominant eye, aiming and shooting an arrow while focusing with the non-dominant eye, or aiming and throwing a dart while focusing with the non-dominant eye.

17. The method of claim 16, wherein the gun, arrow, or dart is aimed at a target, the method further comprising tracking whether the target is hit by shot from the gun, by the arrow, or by the dart, and determining a voltage or pattern of voltages across the electrically controllable optical window that is associated with a higher accuracy of hitting the target.

18. The method of claim 15, wherein the user has amblyopia.

19. A pair of glasses for modifying visual input to the brain, the pair of glasses comprising:
a frame;
two optical windows coupled with the frame, wherein at least one of the optical windows is an electrically controllable optical window; and
a controller electrically coupled with the electrically controllable optical window;
wherein the controller is positioned to establish a voltage across the electrically controllable optical window, remove a voltage across the electrically controllable optical window, vary a voltage across the electrically controllable optical window, or combinations thereof; and
wherein optical transparency of the electrically controllable optical window is responsive to voltage across the electrically controllable optical window.

20. The apparatus of claim 19, wherein the controller is positioned to establish at least two different voltage states across the electrically controllable optical window, wherein in a first voltage state the electrically controllable optical window is in a first state of optical transparency, wherein in a second voltage state the electrically controllable optical window is in a second state of optical transparency, and wherein the first and second states of optical transparency are different.
